(19) United States
(12) Patent Application Publication
(10) Pub. No.: US 2026/0141105 A1
(43) Pub. Date: May 21, 2026

(54) UNIVERSAL INTEGRATED CHIP CARD, UICC, FOR MANAGING PROFILES, AND METHOD

(71) Applicant: GIESECKE+DEVRIENT MOBILE SECURITY GERMANY GMBH, Munchen (DE)

(72) Inventor: Georg KRAMPOSTHUBER, Munchen (DE)

(21) Appl. No.: 18/696,062

(22) PCT Filed: Sep. 28, 2022
(86) PCT No.: PCT/EP2022/025446

§ 371 Date: Mar. 27, 2024

(30) Foreign Application Priority Data
Sep. 29, 2021 (DE) 10 2021 004 912.8

(51) Int. Cl. G06F 21/62

(52) U.S. Cl. CPC G06F 21/6245

(57) ABSTRACT

A UICC, preferably a subscriber identity module, includes at least one profile and a subscription manager. Each profile has a state which is active or inactive. The at least one profile further has a shareable interface object which enables the subscription manager to access each profile regardless of the state of the respective profile.

### FIELD OF THE INVENTION

The invention relates to a Universal Integrated Chip Card, UICC, preferably a subscriber identity module, a method for managing at least one profile of such a UICC, and an installed computer program executable in such a UICC.

In order to use services of a communication network, a terminal device, for example a mobile telephone or a machine-to-machine device, M2M device for short, or a device for using technologies of the Internet of Things, IOT for short, contains a UICC. In this description, the term “UICC” is used synonymously with the terms “eUICC”, “subscriber identity module”, “chip card”, “iUICC”, “integrated eUICC”, “integrated secure element”, “embedded secure element”, “secure element” or “SIM”. The UICC normally comprises one or more profiles which is/are configured to authenticate the UICC or a device in which the UICC is operated in relation to the communication network, for example a mobile network.

### TECHNICAL BACKGROUND

The UICC normally comprises one or more profiles which is/are configured to authenticate the UICC or a device in which the UICC is operated in relation to the communication network, for example a mobile network. No more than one profile can normally be active on the UICC at any given specific time.

These profiles need to be managed, particularly if a plurality of such profiles are present on a UICC.

A secure element, for example, which is provided with two virtual profiles and comprises a first baseband and a second baseband is known from document EP 3 108 674 B1. The first virtual profile and the first baseband form a first pair which is uniquely linked to a first logical communication channel. The second virtual profile and the second baseband form a second pair which is uniquely linked to a second logical communication channel. The secure element comprises a communication component which is configured in such a way that it demultiplexes incoming data which are received via the physical communication interface, and multiplexes outgoing data which are transmitted via the physical communication interface.

A further secure element which comprises a multiplicity of emulated or virtual profiles is known from document EP 3 080 960 B1. A communication component of the secure element can receive a command which comprises an identifier by means of which the profile which is the target of the command is uniquely identifiable. The communication component acts as a multiplexer/demultiplexer for these commands.

The aforementioned secure element managers known from the prior art are based on logical channels. However, these managers based on logical channels are complex in terms of implementation, operation and support, particularly if a manager that is compliant with the GSMA specification is required.

A secure element which has a plurality of profiles designed as contexts containing applets, and also a special system profile are known from document US 2019/0 034 662 A1 from the prior art. Generally speaking, only applets from the same context are allowed to access one another. The system profile is authorized to access an applet from a normal context or profile, insofar as the applet has a shareable interface.

A secure element which has a plurality of partitions is known from document DE 10 2018 001 565 A1 from the prior art.

Document U.S. Pat. No. 8,196,131 B1 from the prior art discloses a secure element which is integrated into a contactless device, such as, for example, an NFC SIM card, and which has a plurality of applications which are designed as a card application (and here, for example, as a banking application), a PPSE directory application or control software application, and wherein the applications in each case have an interface object, a shareable interface object, wherein the interface object of the card application (banking application) and the interface object of the control software application communicate with one another.

### SUMMARY OF THE INVENTION

The object of the invention is to provide a UICC and a method with which profiles of the UICC can be managed in a simple and secure manner, and which are compliant with the GSMA specification.

According to the invention, a UICC, preferably a subscriber identity module, is proposed which comprises at least one profile and a subscription manager, wherein the or each profile has a state which is active or inactive. The at least one profile further has a shareable interface object (SIO) which enables the subscription manager to access each profile regardless of the state of the respective profile.

An interface object, SIO, is preferably an object for implementing an interface functionality of the profile on the UICC. The interface object is shareable, such that other instances, in particular the subscription manager, can access each profile by means of this object.

A subscription manager can access a profile by means of an SIO, regardless of the state of the profile. The profile can be active or inactive. Not only does the SIO enable the subscription manager to access elements of an activated profile, but the subscription manager can also access elements of an inactive profile by means of the SIO.

A profile is, in particular, in the active state (=enabled, activated, active) if the subscription data contained in the profile are currently being used to log in to a mobile network.

A profile is, in particular, in the inactive state (=disabled, non-activated, non-active) if the subscription data contained in the profile are not currently being used to log a terminal device in which the UICC is incorporated ready for operation in to a mobile network.

A profile is a memory area (container, slot) assigned in the UICC. Subscription data (authorization data, network access data, network access credential data, credentials), inter alia, which allow a user (subscriber) to use the services, such as voice and/or data services, of a mobile network are stored in the profile. Use of these services is enabled following a successful login to the mobile network.

To log in to a mobile network, subscription data of an active profile are used for the unique identification and/or authentication in the mobile network of a user (subscriber) of a terminal device in which the UICC is incorporated ready for operation.

According to one preferred embodiment of the UICC, the subscription manager is an application of the UICC for managing the profiles of a UICC.

The subscription manager can be a Root Issuer Security Domain (ISD-R). It is particularly preferable if the subscription manager is a Root Issuer Security Domain (ISD-R) in accordance with the GSM SGP.22 specification, in particular in accordance with the GSM SGP.22 specification in version 2.3 dated Jun. 30, 2021.

The shareable interface object is preferably a Bootstrap Issuer Security Domain Profile (ISD-P) within the profile. A bootstrap is a loading program, also referred to as a bootstrap loader or loader. It is particularly preferable if the Bootstrap Issuer Security Domain Profile (ISD-P) is an Issuer Security Domain Profile (ISD-P) in accordance with the GSM SGP.22 specification, in particular in accordance with the GSM SGP.22 specification in version 2.3 dated Jun. 30, 2021.

According to one preferred embodiment of the UICC, the at least one profile comprises an installer which is registrable (writable) in a system registry, wherein the installer is preferably registrable in the system registry by the shareable interface object.

According to one preferred embodiment of the UICC, the at least one profile comprises a deletion manager which is registrable in a system registry, wherein the deletion manager is preferably registrable in the system registry by the shareable interface object.

According to one preferred embodiment of the UICC, the at least one profile comprises an installer and a deletion manager which are registrable in each case in a system registry, wherein the installer and the deletion manager are preferably registrable in the system registry by the shareable interface object.

A system registry can be the global registry. The system registry is preferably a global registry in accordance with the GSM SGP.22 specification, in particular in accordance with the GSM SGP.22 specification in version 2.3 dated Jun. 30, 2021.

A system registry can be the local registry. The system registry is preferably a local registry in accordance with the GSM SGP.22 specification, in particular in accordance with the GSM SGP.22 specification in version 2.3 dated Jun. 30, 2021.

A system registry can be a registry of the terminal device. A system registry can be a registry of the mobile network.

The at least one profile preferably comprises a further Issuer Security Domain Profile (ISD-P). It is particularly preferable if the further Issuer Security Domain Profile (ISD-P) is an Issuer Security Domain Profile (ISD-P) in accordance with the GSM SGP.22 specification, in particular in accordance with the GSM SGP.22 specification in version 2.3 dated Jun. 30, 2021.

The UICC has, for example, a file system as described in 3GPP TS 11.11 or 3GPP TS 11.14. The file system has files, for example elementary files, EF. An EF contains header data and main data and occurs in three types: transparent EF, linear fixed EF and cyclic EF. The file system of the UICC comprises, for example, dedicated files, DF, which have header data with a hierarchical structure of elementary files, EF, on the UICC. DFs have no data of their own. A DF can be imagined as a directory structure. The file system of the UICC has at least one master file, MF, and represents the master file in the UICC file system.

A UICC within the meaning of the invention is, for example, an electronic module which is reduced in size and resource scope and has a control unit (microcontroller) and at least one interface (data interface) for communication with the device. This communication preferably takes place via a connection protocol, in particular a protocol in accordance with the ETSI TS 102 221 or ISO-7816 standard.

In the case of UICC designs which are implemented as an integrated system on chip, SoC for short, such the “iUICC”, “Integrated eUICC”, “Integrated SE” or “Integrated TRE”, communication takes place via an SoC internal bus. The UICC has an internal or external, secure non-volatile memory area in which subscriber identity data and authentication data are securely incorporated in order to prevent attempted manipulation and/or misuse during the identification and authentication in the network.

In one embodiment, the UICC can be operationally enabled by means of a device, wherein, the UICC in this embodiment is autonomous except for supply signals, such as supply voltage, clock, reset, etc.

The term “UICC” is synonymous with the term “eUICC”, “subscriber identity module”, “chip card”, “iUICC”, “integrated eUICC”, “integrated secure element”, “embedded secure element”, “secure element” or “SIM”. The UICC is, for example, a chip card or a SIM card or a subscriber identity module. The UICC serves to identify a subscriber in a communication network with the machine-readable subscriber identity data stored in the secure, non-volatile memory area, and to authenticate said subscriber for use of services. The term UICC is understood to mean USIM, TSIM, ISIM, CSIM or R-UIM also. A UICC is thus defined, for example, as a USIM application in ETSI TS 131 102. A UICC is thus defined, for example, as a SIM application in ETSI TS 151 011. A UICC is thus defined, for example, as a TSIM application in accordance with ETSI TS 100 812. A UICC is thus defined, for example, as an ISIM application in accordance with ETSI TS 131 103. A UICC is thus defined, for example, as a CSIM application in accordance with 3GP2 C. S0065-B. A UICC is thus defined, for example, as an R-UIM application in accordance with 3GPP2 C.S0023-D.

The UICC can be an integral component within the device, for example a hard-wired electronic component. UICCs of this type are also referred to as eUICCs. In this design, these UICCs are not intended for removal from the device and, in principle, cannot be simply exchanged. UICCs of this type can also be designed as embedded secure elements and are a secure hardware component in the device.

The UICC can also be a software component in a trusted part of an operating system, known as a trusted execution environment, TEE for short, of the device. The UICC is designed, for example, within a secure runtime environment in the form of programs running therein, known as trustlets.

The UICC can also be an integral component of a larger integrated circuit, for example of a modem or application processor. UICCs of this type are referred to as “integrated UICCs”, “integrated TREs”, “integrated eUICCs” or “Integrated Ses”. UICCs of this type are permanently integrated into an SoC as an integrated processor block and can be connected via a bus within the chip.

The UICC can be used for remote monitoring, remote control and remote maintenance of devices such as machines, plants and systems. It can be used for metering units such as electricity meters, hot water meters, etc. The UICC is, for example, an IoT technology component.

The term “terminal device” is preferably used here, wherein the terminal device can primarily be a “terminal” in communication technology. This does not exclude the possibility of a “terminal device” being a “device” in a different technology. The terms “terminal device” and “device” are used synonymously.

A device within the meaning of the invention is in principle a device or a device component having means for communication with a communication network in order to be able to use services of the communication network or in order to be able to use services of a server via a gateway of the communication network. The term is to be understood to include, for example, a mobile device such as a smartphone, a tablet PC, a notebook or a PDA. Multimedia devices such as digital picture frames, audio devices, televisions or e-book readers which similarly have means for communication with the communication network can also be understood as devices.

In particular, the device is incorporated into a machine, an automaton and/or a vehicle. If the device is incorporated into a motor vehicle, it typically has an integrated UICC. The UICC can set up a data connection using the device, e.g. by means of a modem of the device, to a server via the communication network. A server of the device manufacturer, for example, can be contacted with the device in order to operate control units, e.g. ECUs (ECU=Electronic Control Unit) for functionalities of the device. A server in the background system of the mobile network operator, MNO, for example a server for loading updates for software, firmware and/or the operating system of the UICC into the UICC, can be contacted via the UICC.

A command is an instruction or order which is sent from the device. The command is preferably a command in accordance with the ETSI TS 102 221 or ISO/IEC 7816 standard. It can have a command header and a command body.

The UICC preferably comprises an operating system which is stored as an executable in the data memory, and is configured to carry out the steps of the control unit.

In a further aspect, a method is proposed for managing at least one profile of a UICC, preferably of a subscriber identity module according to the invention. The method comprises the steps of:
receiving a command which corresponds to the performance of an operation on a profile;
determining the state of the profile;
calling a function of the shareable interface object in order to perform the operation on the profile if the state of the profile is inactive.

According to one preferred embodiment of the method, a function of the profile is called in order to carry out the operation on the profile if the state of the respective profile is active.

The operation preferably comprises activating the profile, deactivating the profile, creating a profile, deleting the profile, activating an application package linked to the profile and/or deactivating the application package linked to the profile.

According to one preferred embodiment, the method is carried out by an operating system routine of the UICC.

The invention further relates to a computer program product installed as an executable in a UICC and having means to carry out the method steps of the method according to the invention.

The UICC is configured, for example, to set up a logical connection to a server of the communication network in order to use services of the server or of a different server and to exchange data. Connection parameters, for example a unique server address and the data connection protocol that is to be used, are required when a data connection of this type is set up from a UICC to a server. A Card Application Toolkit, CAT for short, of the Subscriber Identity Module in accordance with the ETSI TS 102 223 standard, for example, is used to set up, clear down and operate a data connection.

A communication network is a technical facility on which signals are transmitted with identification and/or authentication of the user. The communication network offers its own services (its own voice and data services) and/or enables the use of services from external instances. The communication network is preferably a mobile network. Device-to-device communication is possible under the supervision of the communication network. In particular, a mobile network, for example, the “Global System for Mobile Communications”, GSM for short, as a representative of the second generation, or the “General Packet Radio Service”, GPRS for short, or “Universal Mobile Telecommunications System”, UMTS for short, as a representative of the third generation, the “Long Term Evolution”, LTE for short, as a representative of the fourth generation, or a 5^{th} generation mobile network with the current working title “5G”, as a communication network, is understood here as a communication network. Communication in the communication network can take place via a secure channel, for example as defined in the ETSI TS 102 225 and/or ETSI TS 102 226 technical standards, for example SCP80, SCP81, or a Transport Layer Security, TLS.

According to the invention, a server is an instance physically remote from the device. The server can be a part of the communication network. Alternatively or additionally, the server is an external instance (i.e. not an instance of the communication network). The server is preferably a server of the device manufacturer for operating control units, e.g. ECUs (ECU=Electronic Control Unit) for functionalities of the device. Alternatively or additionally, the server is a server for remote management of the eUICC, for example an OTA server, for loading updates for software, firmware and/or the operating system of the eUICC into the eUICC.

Subscriber identity data (=subscription data), such as the data stored, for example, in the non-volatile memory area of the UICC, are, for example, data which uniquely identify a subscriber (a person or device) in the communication network. These data include, for example, a subscriber identifier, for example an international mobile subscriber identity, IMSI for short, or subscription permanent identifier, SUPI, and/or subscriber-specific data. The IMSI/SUPI is the subscriber identity file that is unique in the mobile communication network. Subscriber identity data are furthermore, for example, parameters and/or data which enable a subscriber to be uniquely authenticated in the communication network, for example an authentication algorithm, specific algorithm parameters, a cryptographic authentication key Ki and/or a cryptographic over-the-air, OTA for short, key. Subscriber identity data are furthermore, for example, data which uniquely authenticate a subscriber to a service, for example a unique identifier or signature. A service is, in particular, a voice service or a data service of a server with which information and/or data are transmitted via the communication network.

The UICC can be incorporated into the device ready for operation. Communication between the UICC and the device is based on a connection protocol. In addition, the device can further be configured to set up a data connection independently to the physically remote server so that it can similarly use the services of and exchange data with this server.

### BRIEF DESCRIPTION OF THE FIGURES

The invention or further embodiments and advantages of the invention are explained in detail below with reference to figures, wherein the figures merely describe exemplary embodiments of the invention. The same components in the figures are denoted with the same reference signs. The figures are not to be regarded as true-to-scale and, in particular, individual elements of the figures can be represented as exaggeratedly large or exaggeratedly simplified.

FIG. 1 shows a state diagram of a UICC having a multiplicity of profiles according to one exemplary embodiment of the invention;

FIG. 2a shows a diagram of an application bundle which comprises at least one profile of the UICC;

FIG. 2b shows a diagram of a profile management according to the invention;

FIG. 3 shows an exemplary embodiment of a system comprising a network, a device and a UICC according to the invention;

FIG. 4 shows an exemplary embodiment of a UICC according to the invention;

FIG. 5 shows a further exemplary embodiment of a UICC according to the invention;

FIG. 5a shows a further exemplary embodiment of a UICC according to the invention;

FIG. 6 shows an exemplary embodiment of a flow diagram of a method according to the invention in a UICC.

### DETAILED DESCRIPTION OF EXEMPLARY EMBODIMENTS

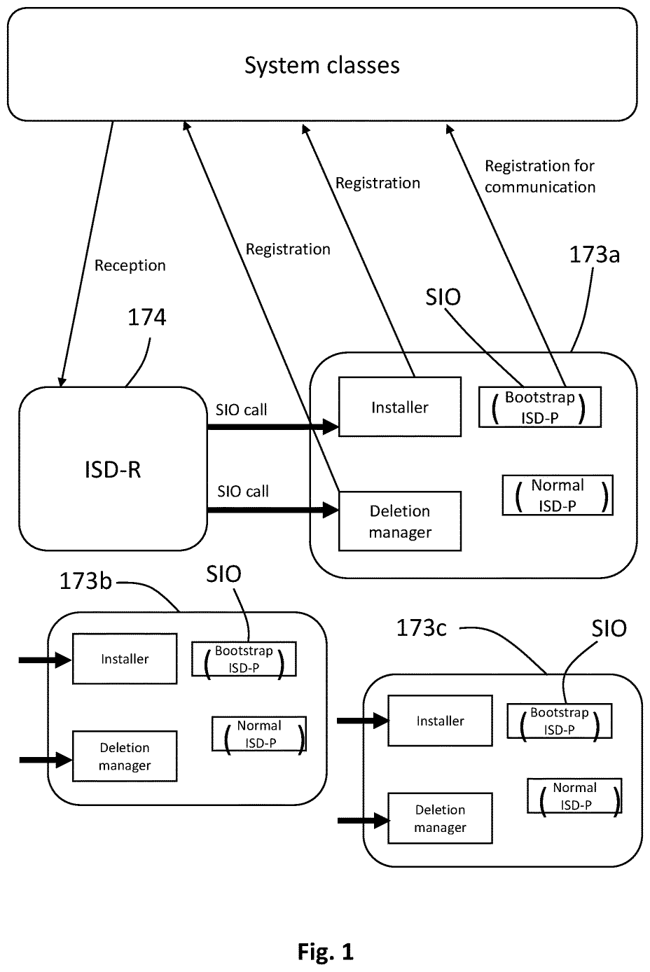

FIG. 1 shows a state diagram of a UICC 1 having a multiplicity of profiles 173a-c according to one exemplary embodiment of the invention. The multiplicity of profiles 173a-c are managed using a method according to the invention. A first profile 173a, a second profile 173b and a third profile 173c are shown by way of example in FIG. 1. Each profile 173a-c has its own respective subscription data. The subscription data of different profiles 173a-c can differ from one another, so that a subscriber can log in to a first mobile radio network using an active profile 173a and the subscriber logs in to the first mobile radio network or in to a second mobile radio network using an active profile 173b.

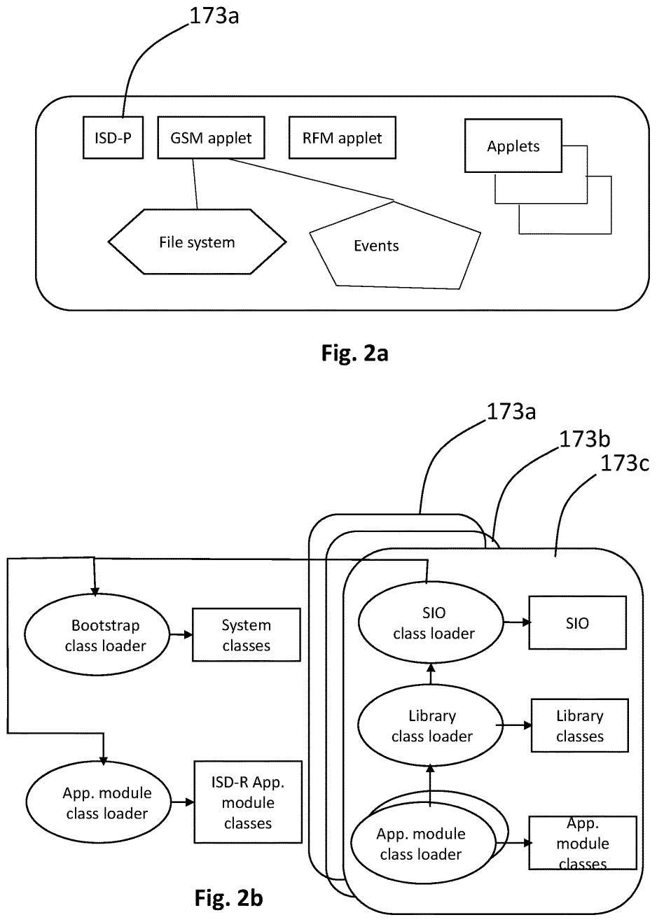

FIG. 2a shows a diagram of an application bundle, also referred to as a container or slot, which comprises at least one profile of the UICC. The profile(s) of the UICC is/are normally installed into an application bundle of this type. The application bundle can be a (virtual) runtime environment, in particular a JavaCard runtime environment, JCRE (in accordance with the JavaCard Classic Edition standard).

The UICC can comprise a plurality of application bundles. These application bundles are intended to be strictly separated from one another in accordance with the GSMA standard and are intended to have applications that are “shielded” from one another. An application bundle can be designed such that it exposes (reveals) none of its own elements to another application bundle.

Along with the profile, FIG. 2 also shows, by way of example, a GSM applet with a file system and events, a remote file management, RFM for short, applet and further applets.

Application bundles can be pre-installed as empty application bundles on the UICC or can be generated dynamically by means of a call via a system programming interface (system API). An API of the UICC is preferably understood as a system API.

FIG. 2b shows a diagram of a profile management according to the invention. The profiles 173a-c are in each case equipped with app module class loaders in order to access applet module classes. The profiles 173a-c are in each case equipped with library class loaders in order to access library classes. The profiles 173a-c are in each case equipped with SIO class loaders in order to access SIO classes. A profile 173a-c can be accessed in both the active state and the inactive state of the profile 173a-c, thanks to the SIO. A bootstrap ISD-P makes this SIO available in order to enable an installation and deletion from outside, regardless of the profile state. The profile 173a-c performs the respective action (in particular installation, deletion) through remote management from the subscription manager ISD-R.

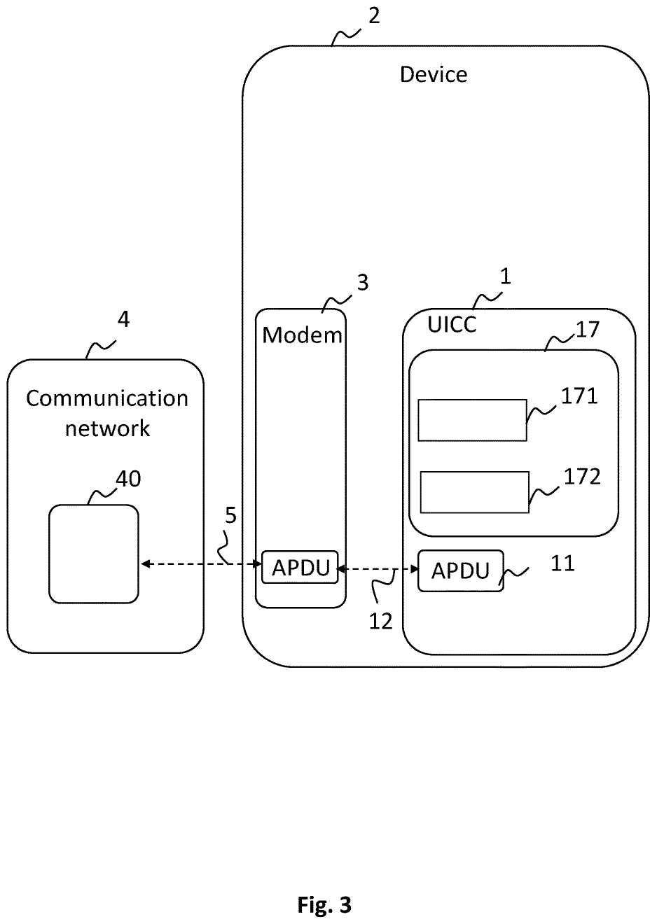

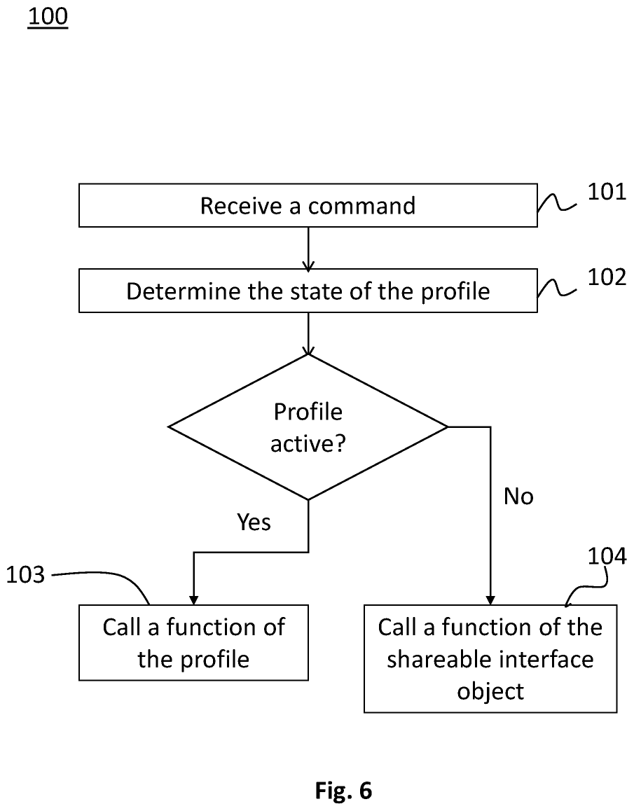

FIG. 3 shows an exemplary embodiment of a system consisting of a device 2 and a UICC 1 according to the invention. The method proceeds in the UICC as shown in FIG. 6. The device 2 is, for example, an M2M device in an IoT environment. The device 2 can have a plurality of ECUs which are not shown here. The functionalities of the device 2 are controlled by these ECUs. If the device 2 is a motor vehicle, the ECUs could be engine control, transmission control, climate control and the like.

The UICC 1 is incorporated into the device 2 ready for operation and is supplied by the device 2 with a supply voltage Vcc and a clock CLK. The UICC 1 is shown in more detail in FIG. 3. FIG. 2 shows that the UICC 1 has a memory 17. Applets, a card application toolkit, CAT, authentication data sets 172 and an authentication data manager 171 can be stored in this memory 17. Different APDU commands 11 can be exchanged between the UICC 1 and the device 2 by means of the applets, the CAT and the operating system (not shown).

The device 2 comprises, for example, but not necessarily, a modem 3. The modem 3 can be regarded, for example, as a logical unit for converting data between the UICC 1 and a server 40 of a network 4. The device 2 can set up a communication connection 12 to the UICC 1 by means of the modem 3. Communication 12 between the device 2 and the UICC 1 takes place in accordance with the protocols which are defined in the ISO/IEC 7816-3 and ISO/IEC 7816-4 international standards and to which specific reference is hereby made.

The entire data exchange between the UICC 1 and the device 2 preferably takes place using APDUs (application protocol data units) in accordance with the ISO/IEC 7816-4 standard. An APDU represents a data unit of the application layer, i.e. a type of container with which commands and/or data are transmitted to the UICC 1. A distinction is made between command APDUs, which are transmitted from a device 2 to the UICC 1, and response APDUs, which are transmitted from the UICC 1 to the device 2 in response to a command APDU.

The modem 3 is a communication unit of the device 2 for also exchanging data of the device 2 or of the UICC 1 with the communication network 4 and the server 40 located therein. The data exchanged between the UICC 1 and the modem 3 can be converted in the modem 3 into an IP-based connection protocol.

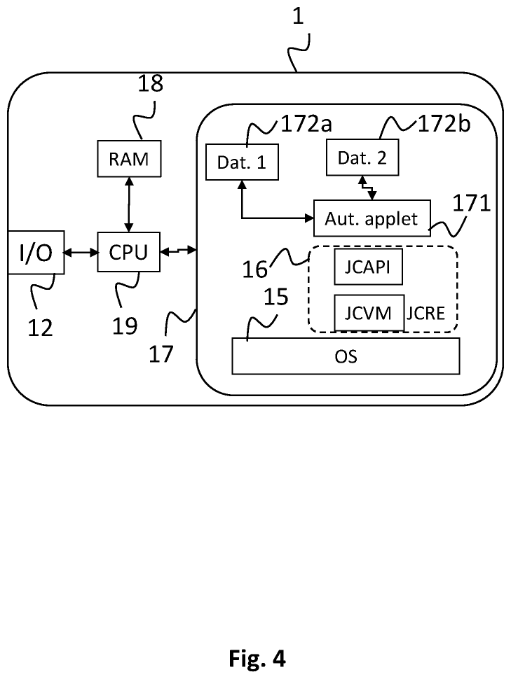

FIG. 4 shows a block diagram of a UICC 1 according to the invention, preferably a hard-wired eUICC. Alternatively, the UICC 1 is a portable data carrier having a different design. The UICC 1 has an operating system 15 in which the method 100 proceeds as shown in FIG. 6. The operating system 15 is, for example, a native operating system. It is further conceivable for the operating system 15 to be configured to operate a JavaCard runtime environment, JCRE, 16, which is then stored in the memory 17 together with the operating system 17.

The UICC 1 is designed to exchange data with the device 2 as shown in FIG. 3. Both the UICC 1 and the device 2 in each case have suitable communication interfaces 12 for the data transmission or communication between the UICC 1 and the device 2. The interfaces can be designed, for example, such that the communication between them or between the UICC 1 and the device 2 is connected galvanically, i.e. with contacts. The contact assignment is defined in ISO/IEC 7816. In one embodiment (not shown), the communication interface is contactless, for example according to an RFID or NFC or WLAN standard.

The UICC 1 further has a central processor or control unit, CPU, 19, which has a communication connection to the interface 12. The primary tasks of the CPU 19 include performing arithmetic and logical functions and reading and writing data elements, as defined by program code executed by the CPU 19. The CPU 19 is further connected to a volatile working memory, RAM 18, and to a non-volatile rewritable memory 17. The non-volatile memory 17 is preferably a flash memory (flash EEPROM). It can, for example, be a flash memory with a NAND or a NOR architecture.

In the preferred embodiment shown in FIG. 4, the program code which can be executed by the CPU 19 is stored in the non-volatile memory 17. In particular, the program code of the chip card operating system, OS, 15, the JavaCard runtime environment, JCRE, 16 (consisting of a JavaCard Virtual Machine, JCVM, and JavaCard Application Programming Interfaces, JCAPI), an application 13 for authentication data management and at least two authentication data sets 171a, 171b can be stored in the non-volatile memory 17. An application, preferably in the form of JavaCard™ applets, is present. A CAT in accordance with ETSI TS 102 223 (not shown) can further be incorporated. A program element written in native code, e.g. in C or in Assembler, can also be provided instead of an application.

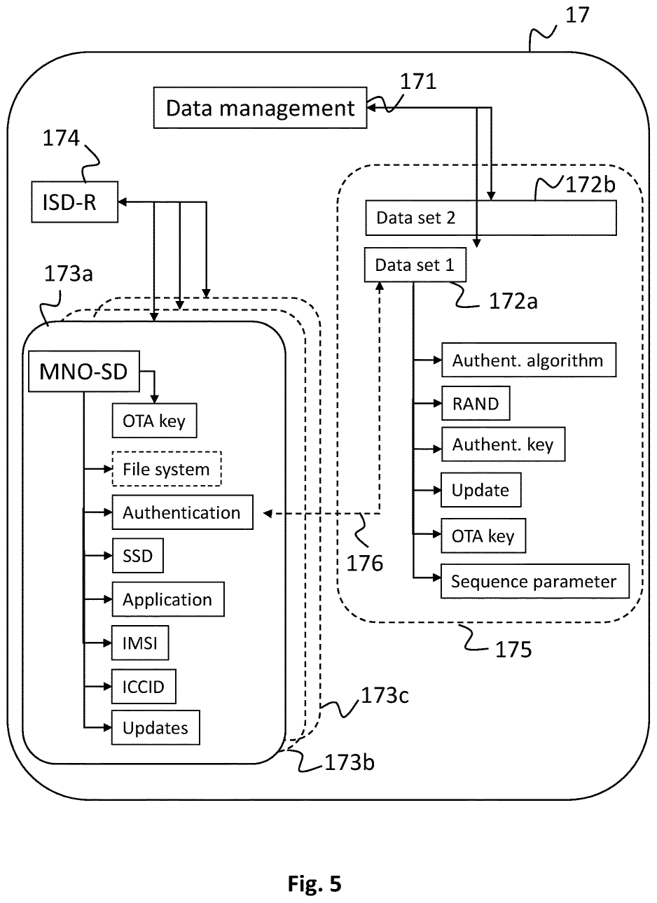

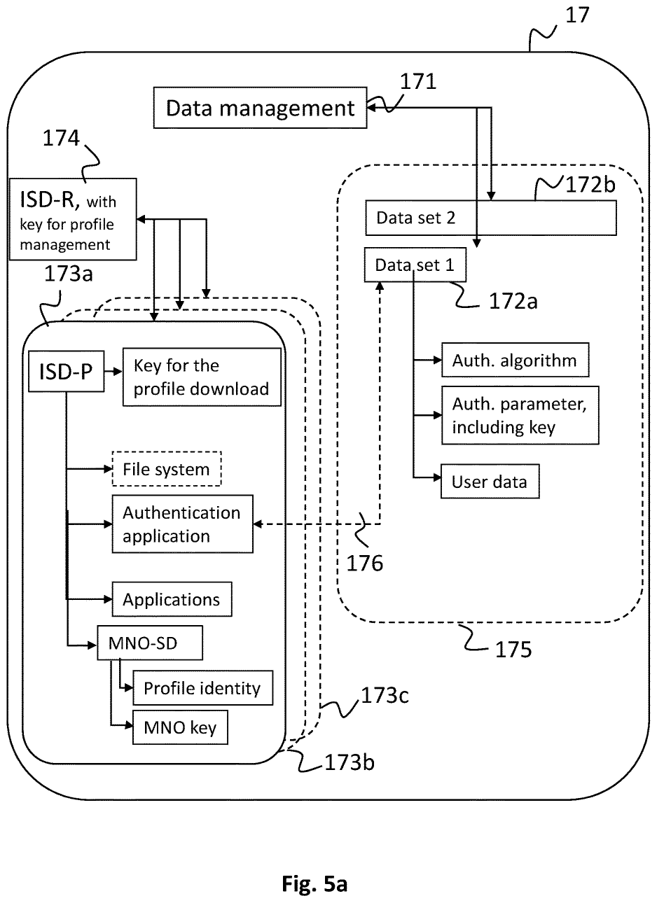

FIG. 5 shows a further exemplary embodiment of a UICC 1, more precisely of a memory area 17 of a UICC 1. The memory area 17 is a non-volatile memory, but can also be a volatile memory (RAM). The memory area 17 can be an exclusively assigned memory area 17 which is part of a larger memory unit. The memory area 17 can be a remote memory area. The memory area 17 of the UICC 1 describes a memory area to which the UICC 1 or the control unit 19 of the UICC has exclusive access. The access rights to the memory area 17, i.e. read, write, overwrite, can be defined in a security domain (SD) so that different subunits of the UICC are granted or denied access to different areas of the file system 175.

The memory area 17 shown in FIG. 5 has, for example (but not necessarily), a subscription manager 174 (ISD-R) which can manage different subscription profiles 173a-c. A profile 173a-c can be managed by means of OTA communication between servers 40 of the communication network, for example subscription servers SM-SR or data preparation servers SM-DP, SM-DP+ in accordance with the GSMA SGP.02 and SGP.22 specifications, for which purpose SMS, CAT_TP or HTTPS, for example, is used for the over-the-air, OTA, communication with the UICC 1. This profile management—which is not part of this description—comprises “creating”, “loading”, “activating”, “deactivating”, “deleting” and “updating”. Reference is made to the aforementioned GSMA specifications for details.

A profile 173a-c has profile data. One of the following components, for example, can be present as a profile file for each profile 173a-c: an MNO security domain (MNO-SD) with the OTA key sets from OTA servers; at least one authentication parameter (Ki, OP, RAND, SGN) or at least one reference 176 (pointer or address) to a corresponding entry 172 in the file system 175 of the UICC 1; a network access application, guideline rules; a profile-specific file system containing DFs and EFs for the respective profile 173a-c; connection parameters of the profile; applications; a subscriber identifier, IMSI, a subscriber identity module identifier ICCID and, where appropriate, profile updates.

According to the exemplary embodiment, the UICC 1 comprises at least one profile 173a-c, in particular a multiplicity of profiles 173a-c, and a subscription manager 174, wherein each profile 173a-c has a state which is active or inactive. The at least one profile 173a-c further has a shareable interface object SIO which enables the subscription manager 174 to access each profile 173a-c regardless of the state of the respective profile 173a-c.

The subscription manager 174 can be a Root Issuer Security Domain (ISD-R), preferably a Root Issuer Security Domain (ISD-R) in accordance with the GSM SGP.22 specification, in particular in accordance with the GSM SGP.22 specification in version 2.3 dated Jun. 30, 2021.

The shareable interface object SIO can be a Bootstrap Issuer Security Domain Profile (ISD-P) within the profile 173a-c, preferably a Bootstrap Issuer Security Domain Profile (ISD-P) in accordance with the GSM SGP.22 specification, in particular in accordance with the GSM SGP.22 specification in version 2.3 dated Jun. 30, 2021. The shareable interface object SIO can accordingly be a Bootstrap ISD-P within the profile 173a-c.

The at least one profile 173a-c can comprise an installer and a deletion manager which are registrable in each case in a system registry, wherein the installer and the deletion manager are preferably registrable in the system registry by means of the shareable interface object.

The at least one profile 173a-c can comprise a further Issuer Security Domain Profile (ISD-P). A corresponding possible embodiment of the invention is shown in detail in FIG. 5a, and is explained in further detail in the figure description for FIG. 5a. The further Issuer Security Domain Profile (ISD-P) is preferably an Issuer Security Domain Profile (ISD-P) in accordance with the GSM SGP.22 specification, in particular in accordance with the GSM SGP.22 specification in version 2.3 dated Jun. 30, 2021.

The UICC 1 further has an authentication data manager 171. The authentication data manager 171 can be stored as an executable in the form of a Java applet in the memory area 17 of the UICC 1. The data manager 171 can also be stored as an executable only as native program code in the memory area 17 of the UICC 1. The control unit 19 performs the authentication data management 171 on demand.

Authentication data sets 172 are further stored in the memory 17 of the UICC 1. Two authentication data sets 172a and 172b are shown by way of example, but the number is not restricted. An authentication data set 172 can comprise various authentication data. This is shown by way of example in FIG. 4 on the basis of the first authentication data set 172a. It has an authentication algorithm (MILENAGE, TUAK) with corresponding authentication parameters, one or more authentication keys (CK, IK, Ki), where appropriate sequence parameters (SGN-MS, SGN-HE counters, other counters) and authentication updates, etc. In addition to the aforementioned elements, an authentication data set 172 can contain further authentication data. As shown in FIG. 5, the authentication data are preferably stored in structured form in the file system 175. However, proprietary files can also be created in order to store the authentication data sets 172.

The authentication data sets 172 can be assigned to a respective profile 173 with a reference 176. In one embodiment of the invention, an area in which the activated authentication data are stored is defined in the file system 175 for this purpose. A profile 173 then accesses this area in order to authenticate the UICC 1 in the server 40 of the communication network 4.

In a different embodiment, the authentication data are then written to the respective memory area of the file system.

Implementation details in this respect are described at length in the technical reports TR 33.834 and TR 133.935 and reference is made herein to the implementations, in particular the updates, according to solutions 4b and 5. If updates are received, they are stored in a memory area of the UICC by means of the authentication data manager 171. To do this, either a new file or a new file structure is created in the file system 175, or a corresponding authentication data set 172 is updated, e.g. overwritten or extended. A reference 176 to the authentication data can further be updated, for example by updating a memory address, updating a pointer or copying the updated authentication datum to the corresponding area of the profile. Only one authentication data set can ever be activated, so that the UICC 1 performs a unique authentication in relation to the communication network.

The data sets are stored, for example in EF files of the UICC 1. Alternatively or additionally, the authentication data can be stored in data objects, for example in data objects of the UICC 1. Alternatively or additionally, the authentication data can be stored in reserved memory areas of the operating system, OS, of the UICC. These different storage locations may possibly require a modification of the data set structure.

The data sets can therefore be stored in differently structured data sets 172a, 172b according to their storage location. The authentication data manager 171 is configured, in particular, to restructure and adapt the stored authentication data, in particular the data sets 172a, 172b of the authentication data, in each case accordingly in order to be able to use them, on one hand, for authentication as intended and, on the other hand, to store them at the desired storage location.

The method according to the exemplary embodiment serves to manage at least one profile 173a-c of a UICC 1 according to the exemplary embodiment. The method comprises the steps of:
receiving 101 a command which corresponds to the performance of an operation on a profile 173a-c;
determining 102 the state of the profile 173a-c;
calling 103 a function of the shareable interface object SIO in order to perform the operation on the profile 173a-c if the state of the profile 173a-c is inactive.

A function of the profile 173 a-c can be called 104 in order to perform the operation on the profile 173a-c if the state of the respective profile 173a-c is active.

The operation can comprise activating the profile 173a-c, deactivating the profile 173a-c, creating the profile 173a-c, deleting the profile 173a-c, activating an application package linked to the profile 173a-c and/or deactivating the application package linked to the profile 173a-c.

According to one preferred embodiment, the method can be carried out by an operating system routine of the UICC 1.

FIG. 5a shows a further exemplary embodiment of a UICC 1, more precisely of a memory area 17 of a UICC 1.

The memory area 17 is a non-volatile memory, but can also be a volatile memory (RAM). The memory area 17 can be an exclusively assigned memory area 17 which is part of a larger memory unit. The memory area 17 can be a remote memory area. The memory area 17 of the UICC 1 describes a memory area to which the UICC 1 or the control unit 19 of the UICC has exclusive access. The access rights to the memory area 17, i.e. read, write, overwrite, can be defined in a security domain (SD) so that different subunits of the UICC are granted or denied access to different areas of the file system 175.

The memory area 17 shown in FIG. 5a has, for example (but not necessarily), a subscription manager 174 (ISD-R) which can manage different subscription profiles 173a-c which are connected in each case by means of an Issuer Security Domain Profile (ISD-P). An Issuer Security Domain Profile (ISD-P), and therefore a profile 173a-c can be managed by means of OTA communication between servers 40 of the communication network, for example subscription servers SM-SR or data preparation servers SM-DP, SM-DP+ in accordance with the GSMA SGP.02 and SGP.22 specifications, and using keys held in the subscription manager 174 ISD-R for profile management, for which purpose, for example, SMS, CAT_TP or HTTPS is used for the over-the-air, OTA, communication with the UICC 1. This profile management—which is not part of this description—comprises “creating”, “loading”, “activating”, “deactivating”, “deleting” and “updating”. Reference is made to the aforementioned GSMA specifications for details.

A profile 173a-c has profile data, as described, for example, in the exemplary embodiment shown in FIG. 5. One of the following components, for example, can be present as a profile file for each profile 173a-c: an MNO security domain (MNO-SD) with the MNO keys from servers of the MNO which is the owner the profile, and with a profile identity; at least one authentication parameter (Ki, OP, RAND, SGN) or at least one reference 176 (pointer or address) to a corresponding entry 172 in the file system 175 of the UICC 1; a network access application, guideline rules; a profile-specific file system containing DFs and EFs for the respective profile 173a-c; connection parameters of the profile; applications; a subscriber identifier, IMSI, a subscriber identity module identifier ICCID and, where appropriate, profile updates.

According to the exemplary embodiment, the UICC 1 comprises at least one Issuer Security Domain Profile (ISD-P) and a profile 173a-c associated therewith, in particular a multiplicity of Issuer Security Domain Profiles (ISD-P) and profiles 173a-c, and a subscription manager 174, wherein each profile 173a-c has a state which is active or inactive. The at least one profile 173a-c further has a shareable interface object SIO which enables the subscription manager 174 to access each profile 173a-c regardless of the state of the respective profile 173a-c.

The subscription manager 174 can be a Root Issuer Security Domain (ISD-R), preferably a Root Issuer Security Domain (ISD-R) in accordance with the GSM SGP.22 specification, in particular in accordance with the GSM SGP.22 specification in version 2.3 dated Jun. 30, 2021.

The shareable interface object SIO can be a Bootstrap Issuer Security Domain Profile (ISD-P) within the profile 173a-c, preferably a Bootstrap Issuer Security Domain Profile (ISD-P) in accordance with the GSM SGP.22 specification, in particular in accordance with the GSM SGP.22 specification in version 2.3 dated Jun. 30, 2021. The shareable interface object SIO can accordingly be a Bootstrap ISD-P within the profile 173a-c.

The at least one profile 173a-c can comprise an installer and a deletion manager which are registrable in each case in a system registry, wherein the installer and the deletion manager are preferably registrable in the system registry by means of the shareable interface object.

In the illustration shown in FIG. 5a, the at least one profile 173a-c comprises a further Issuer Security Domain Profile (ISD-P). The further Issuer Security Domain Profile (ISD-P) is preferably an Issuer Security Domain Profile (ISD-P) in accordance with the GSM SGP.22 specification, in particular in accordance with the GSM SGP.22 specification in version 2.3 dated Jun. 30, 2021.

The UICC 1 further has an authentication data manager 171. The authentication data manager 171 can be stored as an executable in the form of a Java applet in the memory area 17 of the UICC 1. The data manager 171 can also be stored as an executable only as native program code in the memory area 17 of the UICC 1. The control unit 19 performs the authentication data management 171 on demand.

Authentication data sets 172 are further stored in the memory 17 of the UICC 1. Two authentication data sets 172a and 172b are shown by way of example, but the number is not restricted. An authentication data set 172 can comprise different authentication data. This is shown by way of example in FIG. 4 on the basis of the first authentication data set 172a. It has an authentication algorithm (MILENAGE, TUAK) with corresponding authentication parameters, one or more authentication keys (CK, IK, Ki), where appropriate sequence parameters (SGN-MS, SGN-HE counters, other counters) and authentication updates, etc. In addition to the aforementioned elements, an authentication data set 172 can contain further authentication data. As shown in FIG. 5, the authentication data are preferably stored in structured form in the file system 175. However, proprietary files can also be created in order to store the authentication data sets 172.

The authentication data sets 172 can be assigned to a respective profile 173 with a reference 176. In one embodiment of the invention, an area in which the activated authentication data are stored is defined in the file system 175 for this purpose. A profile 173 then accesses this area in order to authenticate the UICC 1 in the server 40 of the communication network 4.

FIG. 6 shows an exemplary embodiment of a flow diagram of a method 100 according to the invention in a UICC 1. A command corresponding to the performance of an operation on a profile 173a-c is received in step 101. The state of the profile 173a-c is determined in step 102. This involves determining, in particular, whether a profile 173a-c is active or inactive.

Depending on the state of the profile 173a-c which is determined for the performance of the operation, the operation is performed on this profile 173a-c by performing a function of the shareable interface object SIO on the profile 173a-c if the profile 173a-c is in an inactive state, or by performing a function of the profile 173a-c itself on the profile 173a-c if the profile 173a-c is in an active state.

The subscription manager 174 is enabled to access each profile 173a-c regardless of its state using the method 100. If the subscription manager 174 wishes to access an active profile 173a-c in order to manage said active profile 173a-c, the subscription manager 174 can call the profile 173a-c directly. If the subscription manager 174 wishes to access an inactive profile 173 a-c in order to manage said inactive profile 173a-c, the subscription manager 174 can call the profile 173a-c indirectly via the shareable interface object SIO, in particular by calling the shareable interface object SIO (shareable interface object call). The profile 173a-c which is the target of the operation (target profile) can be indicated and/or identified by means of an identifier. The call of the shareable interface object SIO can comprise the identifier and/or a content and/or a nature of the operation to be performed on the profile 173a-c (for example installing or deleting an application/a profile 173a-c, installing/deleting a local Issuer Security Domain, activating/deactivating a profile, or other operations defined in GSMA SGP.22). The shareable interface object SIO accesses the target profile 173a-c from within and initiates the operation that is to be performed in the target profile. The shareable interface object SIO designed as a Bootstrap Issuer Security Domain (ISD-P) behaves in the same way as a normal Issuer Security Domain (ISD-P).

During the activation/deactivation, the application bundle registers/deregisters in a communication manager, e.g. in the form of an event framework. As a particular embodiment, the installer and the deletion manager could be part of the shareable interface object SIO.

The UICC 1 can comprise a registry. Data by means of which all entities can be uniquely referenced can be stored in this registry. These data comprise an identifier of the corresponding application bundle and an identifier of the corresponding target profile (in accordance with ISO/IEC 7816). According to this embodiment, based on the active application bundle, the entities which correspond to the identifier of the active application bundle and the subscription manager 174 can be filtered out. In addition, a non-UICC application bundle can be created which has the same interface but is not managed by the subscription manager 174.

All described and/or drawn and/or claimed elements can be combined in any way with one another within the scope of the invention.

1.-10. (canceled)

11. A UICC, comprising at least one profile and a subscription manager,
wherein each profile has a state which is active or inactive,
wherein the at least one profile further has a shareable interface object which enables the subscription manager to access each profile regardless of the state of the respective profile.

12. The UICC according to claim 11, wherein the subscription manager is a Root Issuer Security Domain.

13. The UICC according to claim 11, wherein the shareable interface object is a Bootstrap Issuer Security Domain Profile within the profile.

14. The UICC according to claim 11, wherein the at least one profile comprises an installer which is registrable in a system registry,
wherein the installer is registrable in the system registry by the shareable interface object.

15. The UICC according to claim 11, wherein the at least one profile comprises a deletion manager which is registrable in a system registry,
wherein the deletion manager is registrable in the system registry by the shareable interface object.

16. The UICC according to claim 11, wherein the at least one profile comprises a further Issuer Security Domain Profile.

17. A method for managing at least one profile of a UICC, according to claim 11, comprising the steps of:
receiving a command which corresponds to the performance of an operation on a profile;
determining the state of the profile;
calling a function of the shareable interface object in order to perform the operation on the profile if the state of the profile is inactive.

18. The method according to claim 17, wherein a function of the profile is called in order to perform the operation on the profile if the state of the respective profile is active.

19. The method according to claim 17, wherein the operation comprises activating the profile, deactivating the profile, creating the profile, deleting the profile, activating an application package linked to the profile and/or deactivating the application package linked to the profile

20. A computer program product installed as an executable in a UICC and having means to carry out the method steps of the method according to claim 17.
